(19) United States
(12) Patent Application Publication
(10) Pub. No.: US 2009/0105516 A1
(43) Pub. Date: Apr. 23, 2009

(54) Method And System For Neutralizing Pathogens And Biological Organisms Within A Container

(76) Inventor: Gregory Carl Ryan, Saratoga, WY (US)

Correspondence Address: LEE G. MEYER, ESQ.;MEYER & ASSOCIATES, LLC, 17462 E. POWERS DRIVE, CENTENNIAL, CO, 80015-3046, US

(21) Appl. No.: 12/123,445

(22) Filed: May 19, 2008

Related U.S. Application Data
(63) Continuation-in-part of application No. 11/147,619, filed on Jun. 8, 2005, now Pat. No. 7,373,867.

(51) Int. Cl. A62D 3/10; A62D 3/13; A62D 3/17; A62D 3/178

(52) U.S. Cl. 588/304; 588/301; 588/306; 422/105; 588/310

(57) ABSTRACT

A system for neutralizing contaminants, such as pathogens, toxins, and biological organisms on or within an object, which may be housed in a container, such as an envelope, by focusing a plurality of energies or fields including electromagnetic, electrostatic, magnetic, or acoustic on the object in an amount effective to neutralize such contaminants without substantially deleteriously affecting the object or its contents is provided. A pressurizable chamber has means for focusing the energies or fields on the object, in a continuous fashion, and to concentrate the controlled energies at the object and its contents. A pressurization and evacuating system for expelling air and entrained contaminants from the object allowing a sensor to detect and classify contaminants within the chamber.

The present application is a Continuation-in-Part of U.S. application Ser. No. 11/147,619, now U.S. Pat. No. 7,373,867, filed Jun. 8, 2005 for “A System for Neutralizing a Concealed Explosive within a Container,” which is herein incorporated by reference in its entirety.

### BACKGROUND

The parent application relates to a system for detecting explosives concealed in an object or container, such as baggage, by selective detonation of the concealed explosive with a focused controlled, energy source. The present application relates to using a similar system and method to decontaminate or neutralize pathogens, toxins or biological agents on articles in a container such as files in a file box; or, items in a shipping envelope, such as mail or parcel post.

In recent years, there has been an increasing need for improved techniques of neutralizing and/or decontaminating articles in closed containers that may have been intentionally exposed to biological (pathogens) and/or chemical (toxins) agents which are potentially harmful and even lethal to humans or animals. For example, such articles may have been tainted with biological and/or chemical contaminants as a result of an inadvertent event such as an industrial accident; but, more probably as an act of sabotage or terrorism.

Specifically, there is an increasing need for improved techniques of neutralizing and/or decontaminating contaminated articles that are moved from storage, or shipped by private carriers, as well as by U.S. mail. These contaminated articles, which are usually shipped in sealed containers, have the potential to harm not only the intended recipients, but also significant numbers of individuals who handle and store the parcels. For example, the U.S. Postal Service has recently confronted the problem of handling letters that were contaminated with Anthrax. Not only were recipients of the contaminated mail exposed to harmful Anthrax spores, but numerous postal employees were also exposed to the Anthrax spores which leaked from the tainted parcels, resulting in sickness, and in some cases, death.

Further, significant numbers of individuals were likewise contaminated because the Anthrax spores released from the letters were transmitted through the air. Entire buildings were affected through the buildings' heating and ventilation systems. In some cases, prophylactic antibiotics were generally administered to prevent illnesses. Moreover, because the Anthrax-tainted letters contaminated some mail handling equipment at U.S. Post Offices, other mail passing through the postal system was tainted with the Anthrax by cross-contamination, resulting in additional illness and deaths. Beyond the human toll, buildings and mail handling equipment were subjected to very costly decontamination procedures to remove the potentially harmful Anthrax spores.

Personal inspection of these parcels is prohibitive for two reasons. First, the sheer volume of parcels shipped and handled every day make this procedure physically impossible. Second, the inspectors are subjected to contaminates by the mere act of inspection. One approach to disinfecting and/or decontaminating pieces of mail is to irradiate the mail using various technologies. For example, bulk quantities of the mail may be irradiated by beams of high-energy electrons generated by an electron gun. Such technology has been employed to kill bacteria in food, and similar technology has also been employed to kill bacteria, such as Anthrax, on or within pieces of mail.

However, this approach also has drawbacks in that such irradiation equipment has traditionally been costly. Moreover, the effectiveness of such irradiation equipment has been limited because articles, such as pieces of mail, may become contaminated with one or more of a variety of biological and/or chemical agents. For example, although irradiation equipment employing electron beam technology may be effective in killing Anthrax spores, it may be incapable of destroying other biological contaminants such as HIV and E-Coli, and agents that cause, e.g., smallpox, influenza, plague, and botulism, as well as non-biologic chemical toxins such a nerve agents.

It would, therefore, be desirable to have a system and method of disinfecting and/or decontaminating articles such as files, parcels and pieces of mail. Such a system would be effective for neutralizing toxins and/or disinfecting and/or decontaminating articles that have been exposed to diverse biological and/or chemical contaminants. It would also be desirable to have a neutralizing, disinfecting and/or decontaminating system that is compact, easy to use, and relatively low cost.

Thus, the desired system to disinfect or neutralize chemical and biological agents is not easily achieved. Unfortunately, most prior art decontamination systems do not focus the irradiated energy on the container so that the least amount of energy can be effective in neutralizing the contaminant in the shortest amount of time. Because of the myriad of parcel shapes and sizes, most inspection chambers do not provide for an intensity of directed energy. This failure requires long exposure times and/or a failed neutralization of contaminates. Most systems are set to overcompensate for the effective neutralization time which oft times results in the destruction of the contents sought to be cleansed. For example, some years back, patent files thought to have become contaminated were subjected to mass amounts of irradiation. The affect was to destroy the documents. Many irradiated boxes of files had their contents disintegrated as a result of the decontamination treatment.

It would, therefore, be desirous to have a system for neutralizing contaminates within a container which employs a minimum amount of exposure time, and assures the greatest probability of focusing an effective amount of neutralizing energy on the contained contaminates, irrespective of the nature, shape or composition of the item to be treated. It would also be desirous to have a system where the energy employed could be varied and controlled through a feedback system, as well as a secure system, which would not only contain the contaminant laden object, but neutralize or contain dispersed chemical or biochemical agents.

It will be realized that the foregoing discussion and examples of the related art and the scope of the illustrations related thereto are set forth as background only. Their intent is to be exemplary and illustrative of problems related to the art, as well as prior attempts to address these problems at least in part. They are not, nor are they intended to be exclusive or exhaustive. Nor are they intended, in any manner, to be read as a limitation of the instant disclosure or the appended claims.

### SUMMARY

The following embodiments and aspects thereof are described and illustrated in conjunction with systems, devices and methods which are meant to be exemplary and illustrative, not limiting in scope. In various embodiments, one or more of the above-described problems have been reduced or eliminated, while other embodiments are directed to other aspect and improvements.

A system for neutralizing contaminants, such as pathogens, toxins, and biological organisms on or within an object, which may be housed in a container, such as an envelope, by subjecting such object to an amount of focused energy from at least one energy source selected from electromagnetic, electrostatic, magnetic, acoustic, or combination thereof, effective to neutralize such contaminants without substantially deleteriously affecting the contents of the object is provided. The system apparatus comprises an isolation enclosure and a contaminant neutralizing system including at least one primary energy source for transmitting, emitting, or propagating an amount of energy through the object to be neutralized effective to neutralize the contaminates contained therein without substantially deleteriously affecting the contents of the object. The enclosure is a containment neutralizing chamber having means for focusing the energies or fields on the object, in a continuous fashion, and to concentrate the controlled energies at the contents of the object.

Advantageously, at least one compatible feedback transducer is provided to regulate the power of the transmitted, emitted, or propagated energy. The containment neutralizing chamber protects the surroundings by containment of any escaping residue. The chamber may employ, for example, a “vent” for discharging through a High Efficiency Particle Air (HEPA) filter to external atmosphere from the chamber; and/or a bio-waste handling system. Advantageously, a bio-containment devise, such as a scrubber or thermal oxidizer, is coupled to the chamber.

In one aspect, the chamber communicates with a chamber compression and/or evacuation device, such as a displacement cylinder. The variation in pressure is used to expel contaminants in the object to sensors which can identify a known contaminant and direct the energy system to apply the appropriate energy in the required dosage. The displacement cylinder can also be used “tune” and maximize the effect of the acoustical energy on the object, as well as exhaust the contents of the chamber. In another aspect, the chamber contains a turntable to revolve the object in a manner to more uniformly and evenly radiate the object and help prevent stealth type configurations and packaging of bio-contaminants.

In addition to the summary of exemplary aspects and embodiments described above, further aspects and embodiments will become apparent to the skilled artisan by reference to the drawings and by study of the following descriptions all of which are within, without limitation, the scope of the claims.

### BRIEF DESCRIPTION OF THE FIGURES

Exemplary embodiments are illustrated in referenced figures of the drawings. It is intended that the embodiments and figures disclosed herein are to be considered illustrative and exemplary rather than limiting. The features and advantages of the present invention, without limitation, are hereinafter described in the following detailed description of exemplary embodiments to be read in conjunction with the accompanying drawing figures and will be apparent to one skilled in the art that other embodiments are included, in view of the following, wherein like reference numerals are used to identify the same or similar parts in the similar views in which:

FIG. 1 is a perspective view of the detection apparatus including a partial cutaway showing the interior of the isolation enclosure containing containers to be decontaminated, a vent system, and a displacement cylinder to vary the pressure within the chamber.

FIG. 2 is a partial sectional view of an exterior wall of the system in FIG. 1 showing placement of transducers behind a contaminant impervious lining.

FIG. 3 is a bio-hazard neutralizing device comprised of a thermo-oxidation unit and a scrubber unit.

### DETAILED DESCRIPTION

The present system may be described herein in terms of functional block components and various processing steps. It should be appreciated that such functional blocks may be realized by any number of hardware and/or software components configured to perform the specified functions. For example, the system may employ various integrated circuit or optical components, e.g. memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java or the like.

The present invention may be best understood by referring to the figures. For purposes of simplicity, like numerals may be used to describe like figures. However, it should be understood use of like numerals is not to be construed as an acknowledgement or admission that such feathers are equivalent in any manner. It also be understood that where a plurality of similar features are depicted, not all of such identical features may be labeled on the figures.

In accordance with the system, an isolation enclosure structure, forming a leak proof chamber, is provided with at least one sealable means for ingress. Advantageously, a pressure relief or exhaust port is provided, which is funneled to, for example, the exterior of a building (such as a post office or shipping depot) through a biological filter. The exhaust port also contains a valveing system to allow pressurization of the chamber. The integrity and construction requirements of the isolation enclosure structure need be only sufficient to withstand any pressure applied to the object as further described herein. After treatment, any contaminated atmosphere is vented through the pressure relief channel. Depending upon the contaminant, the exhaust port can communicate with a bio-hazard neutralization system. In another embodiment, the chamber communicates with a compression cylinder which relaxes (expands) to expel contaminants from the object without the necessity of opening the object. In this manner the pressure inside the closed vessel can be raised or a vacuum induced to better expose pathogens, toxins, and/or bio-contaminants on objects contained in enclosures such as envelopes or files boxes. A bio-sensor, located in the chamber, can identify known contaminants.

Primary energy sources are operatively connected to compatible actuators or emitters so that the selected type of primary energy is delivered to each such device (as will be described in detail below), to generate secondary energy which is focused within the chamber on the object to be neutralized. Additionally, a particular method for utilizing multiple energy generators whose energy is transmitted through emitter and/or actuators arrays toward the article in a feedback transducer controlled environment is provided. Advantageously, a transfer apparatus is adapted to move objects to be investigated into and out of the sealed chamber through sealable openings. The operative platform is advantageously positioned on a turntable which can be actuated to rotate the platform and thus the object to provide more uniform energy application.

The system can treat a plurality of configurations and container sizes having various dimensions, but preferably products placed in standard packaging (crates, palettes, containers, boxes envelopes and the like) or other objects of large dimensions which are not easily broken down.

The system is effective in neutralizing a large number of toxins, pathogens and harmful bio-agents. This includes many types of pathogens, whether known or unknown, which can be effectively neutralized and harmlessly disposed of. Embodiments of the present system are particularly suited for neutralizing objects contaminated with dangerous, robust bacterial and viral species including, but not limited to, Anthrax spores, smallpox, protein based toxins such as botulinum toxin, yersinia pestis (plague), francisella tularensis (tularemia), filoviruses, and arenaviruses.

It will be appreciated that energy from various energy sources can indirectly destroy biological structure, as well as chemical bonds. This energy can be transferred to molecular components which include but are not limited to, water, protein components necessary for viral, bacterial or spore function, spore dipicolinic acid, calcium dipicolinate, calcium or other metal ions, viral, bacterial or spore nucleic acids. Energy may be directly transferred to these molecular components by various known mechanisms including, but not limited to, excitation of molecular vibration via generation of harmonic acoustic vibration. Energy may be indirectly transferred to these molecular components by various known mechanisms including, but not limited to, excitation of a molecular component via another molecular component. An example of indirect transfer of energy is the excitation of water associated with a nucleic acid, protein, or both, via chemical bonds including, but not limited to, hydrogen bonds. Water associated with a nucleic acid, protein, or both, then transfers energy to the protein, nucleic acid, or both via conductive heat transfer mechanisms. This secondary neutralization can include dehydration of the organism, as a well as the media in which it is contained.

In accordance with an advantageous embodiment, an apparatus comprising a cylindrical pressurizable isolation enclosure including walls and at least one sealable door; a biological resistant lining which can be sterilized positioned inside the enclosure, adjacent to the walls and each door; an exhaust duct attached to an opening formed through a wall of the enclosure and including, for example, a biological screen, a plurality of sensing transducers, as well as emitters positioned inside the enclosure between the interior of the enclosure wall and the lining is provided. Each emitter is adapted for directing a selected type of secondary energy or field into the chamber upon receipt of a selected type of primary energy from a programmed primary energy source. In this manner, a program of specific energy emission can be affected which advantageously can be “tuned” to a specific object. Program of different energies of different intensities and frequencies are also contemplate.

Advantageously, a belt-way or other suitable conveyance is used to transport the objects to be inspected into and out of the isolation enclosure. Sealable openings, such as sliding doors or the like, are opened to allow object entry and then sealed. The object to be treated is then subjected to varying pressures to expel air from the object which may contain the contaminant which can be detected and identified by use of a sensor. The appropriate energy force is then applied to neutralize the contaminant while providing the least amount of structural harm to the contents of the object, such as a file box containing paper, as will be further described. In one embodiment, a software control cycling program which operates the emitters and/or pressurization valves and/or chamber reconfiguration mechanisms on a prescribed schedule are employed. Advantageously, the platform within the chamber incorporates a turntable to subject the object to an even multidirectional energy force. This is especially useful for high energy emissions such as microwaves. The system includes energy emitters and actuators which include devices for subjecting the objects to a number of frequencies, magnitudes, and energy sources throughout a range designed to neutralize bio-agents, toxins and pathogens.

An example of an isolation enclosure used to form a pressurizable chamber comprises a steel enclosure. In one embodiment, the walls, ceiling and floor are hollow. These hollow cavities are filled with non-adsorbent material, such as plastic beads or the like, and then covered with an bio-resistant surface or membrane which is capable of decontamination or sterilization.

Advantageously, the chamber is vented, for example, through one or more vent pipes which void the exhausted atmosphere from the pressurized chamber. In one embodiment, a compression means, such as, for example, a hydraulic cylinder, communicates with the chamber. This compression means, when cycled, can evacuate and/or compress the atmosphere in the chamber to dislodge packaged or contained bio-agents and/or tune the acoustical energy within the chamber. In another embodiment, biological or biochemical agents dispersed by the treatment are further neutralized by a thermal oxidizer and/or scrubber attached to the vent system. It will be realized by the skilled artisan that a myriad of devices and configurations are useful.

In one embodiment, a scanning device is positioned outside the chamber to initially screen items prior to moving the batch load into the chamber. It is well known that certain materials will shield and otherwise protect contaminants from radiation treatment. In this manner, the contaminates could be concealed within the object to be investigated such as to avoid decontamination in accordance with the instant system. Therefore, it would advantageous, but not necessary, to use the system in series with, for example, a prescreening X-Ray detection system such that containers designed to shield bio-agent carrying objects such as files in a shielded box or the like from energy wave bombardment. These items could be handled differently. Additionally, this initial screening could detect items having a high probability of containing contaminants. If an object is determined to have suspicious characteristics, the object is removed from further processing/handling and intensive screening procedures can be performed. (Such as those disclosed in U.S. Pat. No. 7,373,867.)

A control unit is operatively connected to the transfer apparatus, the screening device, the sealable chamber openings, the sensor and the primary energy sources. In exemplary operation, a belt-way or other suitable conveyance is used to transport the objects to be inspected into and out of the chamber. The pressure tight sealable openings, such as sliding doors or the like, are opened to allow object entry and then sealed. The object to be treated is then subjected to varying pressure to extrude material laden atmosphere from the object without the necessity of opening the container. Based upon sensor reading, the appropriate energy force, as will be further described, in accordance with, for example, a software cycling program which operates the emitters and/or pressurization valves and/or chamber reconfiguration mechanisms on a prescribed schedule, which includes subjecting the object to a number of frequencies, magnitudes, and energy sources through out a range designed to decontaminate the object and its contents, but preserve the integrity of the substrate and/or container in which it resides. In one embodiment, the investigation platform within the chamber comprises a turntable which during the investigation is caused to rotate to subject the object to more uniform energy treatment.

When the package, envelope or container to be treated in the chamber which contains various means for focusing energies and/or fields upon the package, envelope or container to neutralize the pathogens or bio-agents and substances by direct decomposition of the substance and/or vaporization, the system is energized to neutralize contained contaminates. It will be realized by the skilled artisan that all of the functions of the unit may be automated by a programmable logic controller or personal computer to enable the unit to handle a total throughput in excess of, for example, 6-18 pieces per minute.

Exemplary of a suitable device is shown in the attached drawings which contemplate, for example, energies comprised singularly, or in combination, of acoustical, EMF, RF, microwave, and the like. These secondary energies are delivered by actuators and/or emitters placed within the chamber and are advantageously dynamically controlled by feedback transducers located in the chamber which detect the amount of energy which is non-deleterious to the container and objects within, but is of sufficient magnitude to neutralize the contaminants. In one embodiment, a compressor means is used to increase the pressure within the chamber to “tune” the acoustical energy through the container. In another embodiment, a vacuum may be pulled across the chamber to shift or even vaporize pathogens and contaminates. In another embodiment, a means is provided, such as a hydraulic cylinder for vertically moving the object within the chamber to “tune” the energy emitter focus such that the object to be inspected is within the focal range of the emitter. In accordance with one aspect, which may occur in sequence, the energy sources utilized are picked for their ability to deactivate or neutralize the contaminant rather than remove it, although reduction in pressure may mobilize the contaminant such that it is more vulnerable to the neutralizing energy sources.

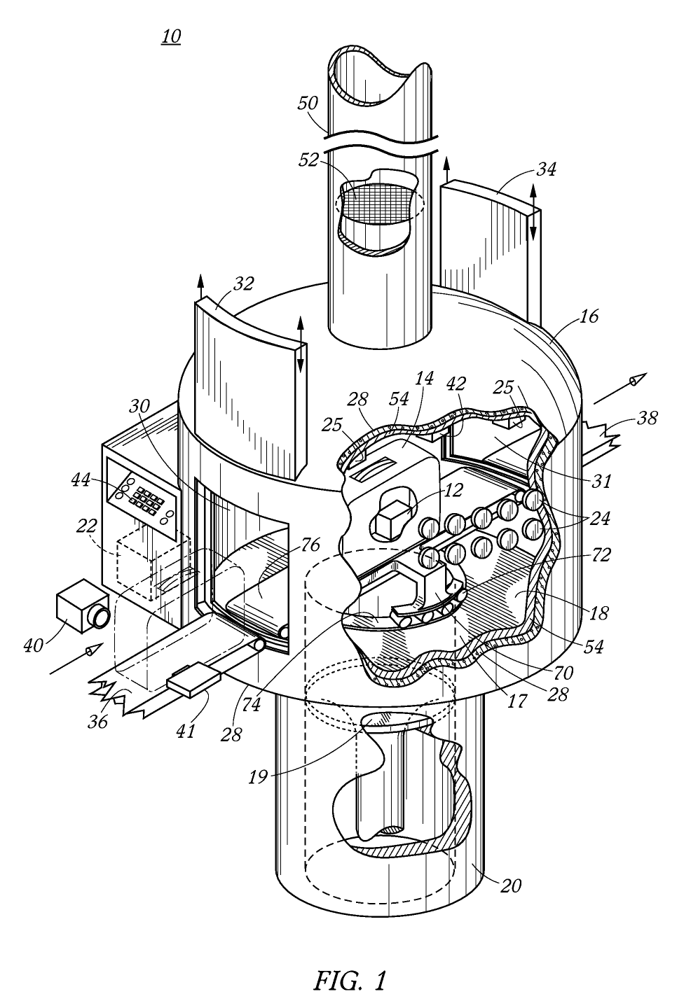

Turning to the drawings, there is shown in FIG. 1 the system 10 for neutralizing concealed bio-agents on a file 12 contained in file box 14 by neutralization/decontamination. System 10 is comprised of a cylindrical isolation enclosure 16 and a pathogen/toxic agent neutralization/decontamination system, as will be further described. Cylindrical isolation enclosure 16 has pressure chamber 18 formed therein to house file box 14 for investigation and/or treatment. A compression cylinder sleeve 20, containing a piston 19, communicates with chamber 18. File box 14 may be an individual container or package or may comprise containers containing multiple object including but not limited to files, mail, garments and the like or it may be a “batch load” comprising a plurality of such packages, cargo container or the like. It also may simply be an envelope with a single letter contained therein.

Advantageously, the cylindrical isolation enclosure 16 is cylindrical in shape, but may be of any configuration. The cylindrical isolation enclosure 16 serves to contain and/or redirect the loosed contaminate material within chamber 18 following the successful neutralization and/or decomposition of the contaminates in file 12. Cylinder sleeve 20 acts as a pressure/vacuum inducing chamber by displacement of piston 19. The pressures and air-born contaminates can be vented into the atmosphere by, for example, exhaust duct 50.

The toxin/pathogen neutralizing system includes at least one primary energy source 22 and at least one emitter/actuator 24 compatible with the primary energy source 22. Each primary energy source 22 is adapted for the generation of a primary source of energy to be used by an emitter/actuator 24. Such energy may include microwaves, radio frequency energy, audio frequency energy, electrostatic, DC electrical currents and AC electrical currents (magnetic) and the like.

Each primary energy source 22 is advantageously located external to but adjacent cylindrical isolation enclosure 16 to minimize the possibility of contamination. One skilled in the art will appreciate, however, that many locations for primary energy source 22 are feasible, provided an operative connection can be formed with emitter/actuator 24. Each emitter/actuator 24 is located within the chamber 18. The compatible emitter/actuators 24 are adapted to receive the first type of energy from at least one primary energy source 22 and to direct a second type of emitted energy and/or field toward file box 14 within chamber 18.

Those skilled in the art will appreciate that the exact functional configuration of each emitter/actuator 24 will be dependent on the nature of the primary energy source 22 to which it is coupled. For example, where the primary energy source 22 is a magnetron or a klystron or other source of microwave frequency energy, emitter/actuator 24 may be a microwave antenna or wave guide; where the primary energy source 22 is a radio frequency generator, emitter/actuator 24 may be a directional radio frequency antenna; where the primary energy source 22 is an audio frequency generator, emitter/actuator 24 may be an audio frequency acoustic (speaker) device; and where the primary energy source 22 is a direct current or alternating current generator, emitter/actuator 24 may comprise magnetic coils or electromagnets. In addition, emitter/actuator 24 may be either a single emitter or a plurality in an “array” consisting of like emitters spatially arranged within chamber 18. A single system need not employ all the energy sources or emitters.

The energy directed by emitter/actuator 24 at file box 14 interacts with contents of file 12 so as to neutralize the contaminants through decomposition, vaporization, molecular rearrangement and the like. Breaking of pathogen DNA also neutralizes living bio-agents. For purposes of illustration only, bacteria, such as Anthrax, may be rendered harmless (killed) by directing short bursts of high power microwave energy at various frequencies at file box 14.

Further, acoustic energy in the form of audio frequency sweeps, i.e. audio frequency energy generated by primary energy source 22 which comprises, for example, a high power audio amplifier, is directed at file box 14 by emitter/actuator 24 which comprise audio emitters (e.g. audio speakers or the like). In one aspect, file 12 may contain deadly viruses sensitive to rapid changes in pressure or acoustic vibrations in the non-audible range. Curtain bio-agents are contained in a medium or substrate which will evaporate or disintegrate under vacuum, drying the bio-agent and thus destroying it. Therefore, when the chamber is compressed, the bio-agent may rupture; or, when evacuated may dehydrate or rupture thus neutralizing the bio-agent.

In one aspect, the piston 19 in the cylinder sleeve 20 is employed to vary the pressure within chamber 18 for specific purposes including a pressure harmonic. When the resonant frequency is produced to destroy the organism, the contaminant will vibrate with enough force to rupture the cell. It will be realized that the cylinder sleeve 20 can be of any size consistent with volumetric requirements. Thus, volumes which in effect double the size of the chamber 18 are within the scope. First, pressurization and/or depressurization of the chamber can affect molecular structures of organisms without affecting the contents of the file box 14. Second, pressurization of the chamber 18 can “tune” the chamber in a manner to intensify the effect of the acoustical energy. Finally, as previously described, the pressure variation can exude contained contaminants which can be detected by sensor.

The system thus allows the neutralization of pressure sensitive bio-materials, toxins, and organisms. Moreover, this neutralization may be accomplished directly by molecular dehydration or media dissipation without destruction or decomposition of the contents of packages, envelopes, or files.

Still, other bio-materials within file 12 may be neutralized by directing an effective amount of high frequency energy in the microwave range produced by primary energy source 22 which comprises magnetrons or klystrons at file box 14 in short pulses, thereby producing sufficient molecular excitement to decompose or rupture organisms. Feedback transducers 25 are used to monitor the power of the directed energy to destroy the bio-agent without harming the contents of the object.

Referring again to FIG. 1, a plurality of primary energy sources 22 producing different forms of energy will be coupled with a plurality of emitter/actuator 24 or emitter arrays 24 to increase the probability of neutralizing the contaminate within file 12. The secondary energy emissions can be in parallel or series depending on the interference and time constraints. The sources may also be multi-spectral capable of generating energy waves of myriad of frequencies within an amplitude, as well as the ability to generate a single and or a number of differing amplitudes.

The following is by way of explanation and not limitation. Advantageously, standing wave patterns are directed and focused on the object to maximize the energy to effect rapid destruction of a pathogen. When two waves of the same frequency meet while moving along the same medium, interference will occur to produce a resultant wave. Thus, the resultant is the addition of the two individual waves together in accordance with the principle of superposition. The result of the interference of these two waves is a new wave pattern referred to as a standing wave pattern.

Thus, standing waves are produced whenever two waves of identical frequency interfere with one another while traveling in opposite directions along the same medium. Standing wave patterns are characterized by certain fixed points along the medium which undergo no displacement. These points of no displacement are called nodes. These nodes are the result of the destructive interference of the two interfering waves. Midway between every consecutive nodal point are points which undergo maximum displacement. These points are called anti-nodes. Anti-nodes are points along the medium which oscillate between a large positive displacement and a large negative displacement. The anti-nodes are the result of the constructive interference of the two interfering waves.

The standing wave patterns of the system 10 are produced as the result of the repeated interference of these two waves to produce nodes and anti-nodes. The anti-nodes resulting from constructive interference of the two waves undergo maximum displacement (amplitude) from the rest position focusing substantial energy on the file box 14. These standing waves can be produced from propagated waves traveling in opposite directions or a single propagated wave reflected from a barrier (like a wall). Both types are intended for inclusion herein.

The standing wave patterns of the system 10 can be produced at a number of frequencies such that each frequency is associated with a different standing wave pattern. These frequencies and their associated wave patterns are referred to as harmonics. In this manner, standing wave fields result in focused energy emissions at a specific location within the chamber at the placement point of the object to be decontaminated.

In order to tune the harmonics of acoustical waves, the density of the medium (air) within the chamber can be changed. As previously described, the pressure (density of the medium) may be varied by means of moving piston 19 within cylinder sleeve 20. In addition to triggering pressure sensitive emissions from the object, the change in pressure intensifies the acoustical energy of the acoustical emitter delivered to the object.

It will be realized by the skilled artisan that a number of pathogens, toxins, and bio-agents are known to present a particular social threat when concealed and/or transported in files, letter, and packages which move through postal and transport systems. These pathogens, toxins and/or bio-agents thus can be isolated in the laboratory and empirically subjected to various energy sources to determine their sensitivity and ability to be neutralized. In accordance with the instant system, suspected pathogens, toxin and/or bio-agents can thus be selectively neutralized, destroyed, decomposed, dehydrated, and the like by use of a computerized look-up table which subjects the suspected object or package to a given set of predetermined energy sources, pressure conditions, acoustic vibrations, and the like. This increases the probability that known and/or suspected containments would be neutralized in the accordance with the operation of the instant system. In addition, newly discovered mutations and/or strains can be added to the database as their discovery and information regarding their neutralization becomes available.

Solely for illustration, the following description of, but one, exemplary system is set forth. Returning to FIG. 1, the cylindrical isolation enclosure 16 comprises a walled enclosure 28 having a sealable ingress passageway 30 formed therethrough and at least one closable portal door 32. As seen in FIG. 1, closable portal door 32 seals sealable passageway 30 while opposing closable portal door 34 forms a sealable egress passageway 31. Each closable portal door 32 and 34 is selectively movable between an open position (shown) which allows ingress and egress from cylindrical isolation enclosure 16 and a sealed closed position (not shown). Once the file box 14 is within chamber 18, the closable portal doors 32 and 34 are moved to their respective closed and sealed positions.

In an advantageous aspect for handling multiple objects such as in a package or mail handling facility the system 10 comprises a file box handling apparatus comprising an ingress conveyer 36 for transferring file box 14 into the cylindrical isolation enclosure 16 through sealable ingress passageway 30, and an output means comprising an egress conveyer 38 for transferring file box 14 out of said cylindrical isolation enclosure 16 through egress passageway 31. Those skilled in the art will appreciate that the use of belted conveyors will allow easy interface with the file box handling systems in most airports, however, many other forms of file box handling apparatus would be readily apparent.

System 10 also advantageously contains a means for venting or exhausting the neutralized vapors and products away from the pressurizable chamber 18. For example, chamber 18 communicates with an exhaust duct 50 through the wall of cylindrical isolation enclosure 16. Exhaust duct 50 allows for venting pressurized waste products generated within chamber 18. Exhaust duct 50 may further comprise a filter 52. Filter 52 is advantageously positioned in the interior of exhaust duct 50 and acts to filter and/or neutralize atmosphere from the chamber 18 while allowing venting of excess pressures and waste gasses. It will be realized that an exhaust fan (not shown) may also be used to exhaust the air in the chamber 18.

In FIG. 1, there is shown an advantageous aspect, which may be employed within the system 10. A turntable 70 is rotationally mounted on wheeled bearings 72, which movably rests on raceway 74 attached to the floor 17 of cylindrical isolation enclosure 16. Turntable 70 is structurally connected to internal conveyor 76 such that as turntable 70 is caused to move by motor means (not shown) internal conveyor 76 rotates therewith. In this manner, the system 10, when in operation, is able of exposing file box 14 and, thus, pathogens, toxins, and bio-agents in file 12 to secondary energy from every angle of the object in a uniform manner. This prevents pathogens, toxins and bio-agents from being placed in a manner to present a “stealth” configuration to the energy produced within cylindrical isolation enclosure 16.

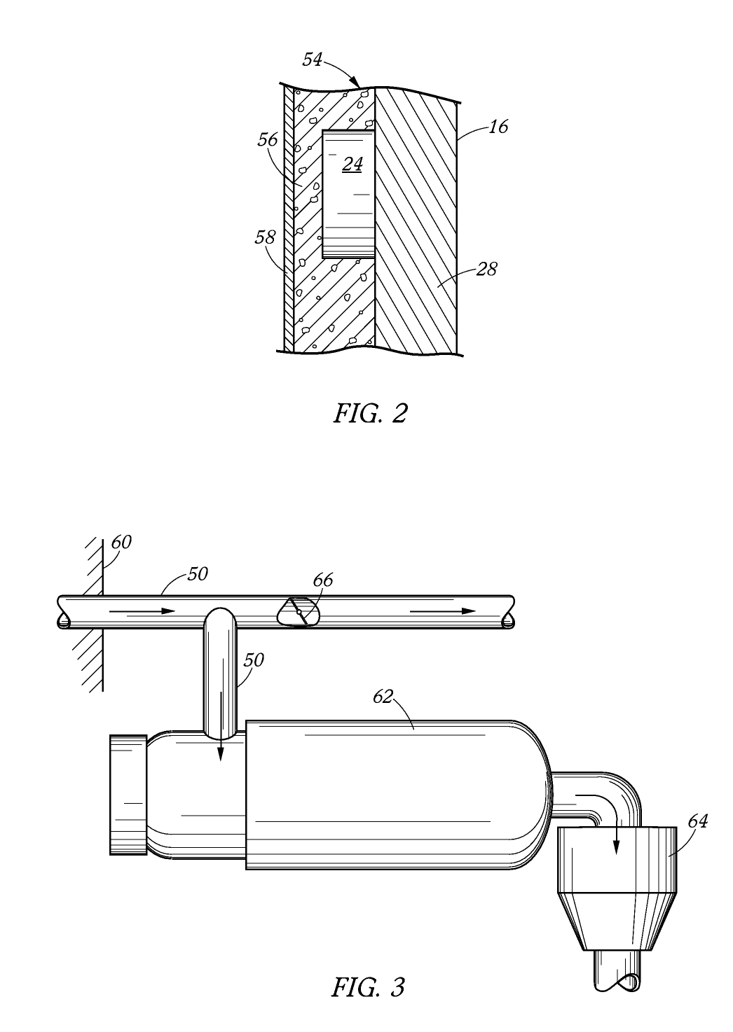

Cylindrical isolation enclosure 16 can be constructed, for example, in the following manner. Cylindrical isolation enclosure 16 may comprise a pathogen, toxin, bio-agent resistant lining 54. Referring now to FIG. 2, contaminant resistant lining 54 is shown positioned in the interior of cylindrical isolation enclosure 16 between chamber 18 and enclosure wall 28. Emitter/actuator 24 is positioned within non-porous material 56 proximate enclosure wall 28 so as to be protected from the contaminants within chamber 18. Lining 54 may comprise, for example, the lining material 56 of contaminant resistant closed cell plastic foam; and, an impervious second layer 58 of material which presents a contaminant barrier. Those skilled in the art will appreciate that many different configurations of lining 56 are possible, including, as variations of those shown in FIG. 2.

Turning to FIG. 3, there is shown a bio-hazard elimination exhausting system in accordance with one aspect of the described system. The chamber 18 contains a pressure valve (not shown) to allow pressurization of chamber 18 as previously described. Exhaust duct 50 is extended exterior the building as illustrated by exterior wall 60 and “T”ed to a thermal oxidizing unit 62, which communicates with scrubber 64. As can be seen in FIG. 3, exhaust duct 50 contains a valve 66, which can be closed when objects atmospheres needing further treatment are suspected.

In accordance with one aspect, once the hazardous agent is verified with butterfly valve 66 in the closed position, exhaust gases (as shown by the arrows in FIG. 3) exit the chamber 18 through filter 52 traveling through the “T” in the exhaust duct 50 into thermal oxidizer 62. Thermal oxidizer 62 is a piece of equipment well known to those skilled in the art, for oxidizing materials at very high temperatures, thus, thermally degrading them. These devices operate in the thousands of degree range and are effective in thermally degrading substantially all bio and chemical constituency in the exhaust stream.

Scrubber 64, which communicates with the exhaust stream of thermal oxidizer 62, can be any device well known in the art for isolating, or reacting, degradation product of the thermal oxidizer 62. In operation, once the pressure within chamber 18 has dissipated to ambient, piston 19 is actuated within cylinder sleeve 20 to compress the atmosphere of chamber 18 exhausting the remainder of the contents.

System 10 may also comprise X-Ray scanning device 40 to initially screen objects entering the pressurizable chamber 18 to detect items that are stored or packed in energy resistant containers or containing explosives. In this manner, these items can be examined manually by skilled personnel.

As previously disclosed, system 10 may also be automated to expedite the screening and to track items that have been successfully investigated within the system. An automatic control system includes an optical scanning device for tracking items such as by bar code (not shown), an atmosphere sampling sensor 42 and a control unit 44. Sampling sensor 42 is a means for sampling minute amounts of material emitted from within a parcel (so that the presence of potential chemical and biological threats in the air that is sampled can be detected). Within the automated unit is a means for determining if a threat may exist in the sample based upon the relative number of particulates contained in the sample or upon a quality of the particulates. Optional additional subsystems include an archiving sampler that retains a solid sample of the particulates for archival purposes, one or more identification units for processing a sample to determine if the particulates are a specific chemical or biological agent. Preferably, the system is equipped with HEPA filters and operates under negative pressure to reduce a risk of spreading any contaminants beyond the system.

In operation, after the chamber 18 is sealed, a pressure is induced and/or a vacuum pulled on the chamber to expel air and thus material from the package or object. The sensor 42 is then able to “sniff” the expelled air an alert to known hazards within the database. The appropriate energy can then be applied to decontaminate the object.

The identification scanner 41, such as an optical scanning device, is positioned to allow the scanning of file box 14 prior to transferring the file box into chamber 18. It will be realized by the skilled artisan that the identification scanner 41 comprising an optical bar code scanner could scan optical bar code tags affixed to file box 14 in a conventional manner. However, other forms of identification scanning could be used, including magnetic resonance, optical character recognition artificial intelligence means, and the like. As detailed above, sensor 42 is adapted to detect the presence of known hazards within the chamber 18. The sensor 42 operates as a signal to the automated system that a hazardous material has been detected.

The control unit 44 will trigger the appropriate response. Control unit 44 is operatively connected to the file box handling conveyers 36, 38 and 76; closable portal doors 32, 34; primary energy source 22 and sensor 42. Control unit 44 could sequentially operate system 10 in the following exemplary manner: ingress conveyer 36 moves batch load past the X-Ray scanning device 40 and then an identification scanner 41 which identifies article of file box 14 by means of, for example, a file box tag bearing a bar code or a shipping label, allowing the information to be recorded. Ingress conveyer 36 then transfers file box 14 into the cylindrical isolation enclosure 16. After cylindrical isolation enclosure 16 has been sealed to the atmosphere by closing closable portal doors 32 and 34, primary energy source 22 is energized sending energy to emitter/actuator 24 located within chamber 18 which, in turn, focus energy or fields, including standing waves, toward file box 14, all as previously described. Feedback transducers 25 detect the energy intensity within the chamber and signal the primary source to boost or diminish the power or gain on emitter/actuator 24. In this manner, there is continual feedback to the system to avoid harm to the non-contaminate material within file box 14. Turntable 70 is actuated to rotate file box 14 exposing the contents to uniform energy.

The energies or fields interact with file 12 contained within file box 14 causing decontamination thereof. The atmosphere is sealably contained by cylindrical isolation enclosure 16 and closable portal doors 32 and 34. This atmosphere is then vented to the atmosphere by exhaust duct 50. Piston 19 is caused to travel within the cylinder sleeve 20 to push the atmosphere through exhaust duct 50 and filter 52, as previously described. Filter 52 traps expelled particles inside exhaust duct 50 to prevent them from being expelled into the atmosphere. If the object is treated without further detection of contaminate, closable portal doors 32 and 34 are opened and internal conveyer 76 and egress conveyer 38 operate to transfer file box 14 from the chamber 18.

Although the system and method of the present invention have been described with respect to specific embodiments thereof, various changes and modifications to the preferred embodiments may be suggested to those skilled in the art, and it is intended that the present invention encompass such changes and modifications as fall within the scope of the appended claims.

All of the methods and systems disclosed and claimed herein can be made and executed without undue experimentation in light of the present disclosure. While the methods and systems of this invention have been described in terms of embodiments, it will be apparent to those of skill in the art that variations may be applied to the methods and systems and in the steps or in the sequence of steps of the methods described herein without departing from the concept, spirit, and scope of the invention. Various substitutions can be made to the hardware and software systems described without departing from the spirit of the claimed invention. All such similar substitutes and modifications apparent to those skilled in the art are deemed to be within the spirit, scope, and concept of the claimed invention.

What is claimed is:

1. A system for neutralizing contaminants such as pathogens, toxins, and biological organisms on or within an object without substantially deleteriously effecting the object or the contents therein by selective neutralization of the contaminates comprising:
a.) an isolation enclosure forming a leak proof pressurizable chamber for retaining the object having at least one sealable portal for ingress and egress and a vent in communication with said chamber for expelling the contents of said chamber subsequent to said selective neutralization;
b.) at least one regulatable primary energy source for transmitting, emitting, and/or propagating a controlled, focused amount of energy on the object and the contents therein;
c.) at least one feedback loop located in said chamber for each of said at least one primary energy source to monitor the amount of energy being emitted from said at least one regulatable primary energy source;
d.) at least one regulator in communication with said feedback loop for controlling the amount of energy being emitted from each of said at least one regulatable primary energy source wherein said amount of controlled, focused energy from said at least one energy source is effective to neutralize said contaminate on or within said object, but insufficient to deleteriously affect said object or the contents therein.

2. The system of claim 1 wherein the regulatable primary energy source is selected from electromagnetic, electrostatic, magnetic, acoustic, or combinations thereof.

3. The system of claim 1 further comprising a cylinder sleeve in communication with the isolation enclosure having a piston for selectively pressurizing and depressurizing the chamber to expel air and entrained contaminants from said object.

4. The system of claim 1 further comprising a sensor for detecting contaminants within the chamber.

5. The system of claim 1 wherein the controlled, focused amount of energy comprises a standing wave pattern.

6. The system of claim 1 wherein the regulatable primary energy sources are multi-spectral, being capable of generating energy at a myriad of frequencies within an amplitude and a number of differing amplitudes.

7. The system of claim 1 further comprising a cylinder sleeve in communication with the isolation enclosure having a piston for selectively pressurizing and depressurizing the chamber to tune acoustic energy from the acoustic primary energy source.

8. The system of claim 1 wherein said at least one feedback loop located in said chamber comprises at least one compatible feedback transducer to regulate the power of the transmitted, emitted, or propagated energy.

9. The system of claim 1 further comprising a turntable to revolve the object in a manner to more uniformly and evenly subject the object to the controlled, focused amount of energy.

10. The system of claim 1 wherein the regulatable primary energy source is selected from a magnetron source of microwave frequency energy which actuates an emitter/actuator in the form of a microwave antenna or wave guide; a radio frequency generator which actuates an emitter/actuator directional radio frequency antenna; an audio frequency generator which actuates an emitter/actuator in the form of an audio frequency acoustic device; a direct current or alternating current generator which actuates an emitter/actuator comprising magnetic coils or electromagnets, and combinations thereof.

11. The system of claim 1 wherein the at least one regulatable energy source comprises a plurality of regulatable energy sources which actuate a plurality of focused, controlled emitter/actuators in an array consisting essentially of a plurality of like emitter/actuators spatially arranged within the chamber.

12. The system of claim 1 further comprising a biological and/or chemical handling system in communication with said vent.

13. The system of claim 1 further comprising a transfer apparatus adapted to move the object into and out of the chamber through the at least one sealable portal.

14. A method for neutralizing contaminants such as pathogens, toxins, and biological organisms on or within an object without substantially deleteriously effecting the object or the contents therein by selective neutralization of the contaminates comprising the steps of:
a.) retaining the object in an isolation enclosure forming an pressurizable chamber having at least one sealable portal for ingress and egress and a vent in communication with said chamber for expelling the contents of said chamber subsequent to said selective neutralization;
b.) sealing said chamber;
c.) focusing a controlled amount of energy on the object from at least one transmitting, emitting, or propagating regulatable primary energy source;
d.) monitoring the amount of energy being emitted from the at least one transmitting, emitting, or propagating primary energy source;
e.) controlling the amount of focused energy at the object effective to selectively neutralize the contaminates, but insufficient to deleteriously affect said object or the contents therein.

15. The method of claim 14 wherein the regulatable primary energy source is selected from electromagnetic, electrostatic, magnetic, acoustic, or combinations thereof.

16. The method of claim 14 comprising the further step of selectively pressurizing and depressurizing the chamber to expel air and entrained contaminants from said object.

17. The method of claim 14 wherein the effective amount of controlled energy comprises a standing wave pattern.

18. The method of claim 14 wherein the regulatable primary energy sources are multi-spectral being capable of generating energy at a myriad of frequencies within an amplitude and a number of differing amplitudes.

19. The method of claim 14 comprising the further step of selectively pressurizing and depressurizing the chamber to tune the acoustic energy.

20. The method of claim 14 wherein the step of regulating the power of the transmitted, emitted, or propagated energy is by means of at least one compatible feedback transducer.

21. The method of claim 14 comprising the further step of revolving the object within the chamber in a manner to more uniformly and evenly subject the object to the controlled, focused amount of energy.

22. The method of claim 14 wherein the primary energy source is selected from a magnetron source of microwave frequency energy and actuating an emitter/actuator in the form of a microwave antenna or wave guide; a radio frequency generator, actuating an emitter/actuator directional radio frequency antenna; an audio frequency generator actuating an emitter/actuator in the form of an audio frequency acoustic device; a direct current or alternating current generator actuating an emitter/actuator comprising magnetic coils or electromagnets and combinations thereof.

23. The method of claim 14 wherein the at least one regulatable energy source comprises a plurality of regulatable energy sources which actuate a plurality of focused, controlled emitter/actuators in an array consisting essentially of a plurality of like emitter/actuators spatially arranged within the chamber.

24. The method of claim 14 comprising the further step of neutralizing biological and/or chemical contaminants from the object subsequent to said neutralization through said vent.
